(19) United States
(12) Patent Application Publication
(10) Pub. No.: US 2025/0182327 A1
(43) Pub. Date: Jun. 5, 2025

(54) MULTI-LENS COPLANAR CALIBRATION SYSTEM AND METHOD

(71) Applicant: INDUSTRIAL TECHNOLOGY RESEARCH INSTITUTE, Hsinchu (TW)

(72) Inventors: Chien-Chun KUO, Tainan City (TW); Kai-Shiang GAN, Tainan City (TW); Chung-Li TAI, Tainan City (TW); Jhe-Ruei LI, Tainan City (TW)

(73) Assignee: INDUSTRIAL TECHNOLOGY RESEARCH INSTITUTE, Hsinchu (TW)

(21) Appl. No.: 18/396,467

(22) Filed: Dec. 26, 2023

(30) Foreign Application Priority Data
Nov. 30, 2023 (TW) 112146575

(51) Int. Cl. G06T 7/80; G06T 15/00; G06V 10/25

(52) U.S. Cl. CPC G06T 7/80; G06T 15/00; G06V 10/25

(57) ABSTRACT

A multi-lens coplanar calibration method is applicable to a three-dimensional (3D) imaging device with a plurality of lenses, and the method includes: shooting a reference surface by the 3D imaging device through the plurality of lenses to generate a plurality of 3D images, calculating a plurality of surface equations according to 3D information of the 3D images by a computing device, calculating a plurality of coordinate systems corresponding to the plurality of lenses according to the plurality of surface equations, where one of the plurality of coordinate systems is a first coordinate system, and each of the others is a second coordinate system, calculating a calibration matrix for each second coordinate system relative to the first coordinate system according to at least the plurality of coordinate systems by the computing device, and adjusting based on the calibration matrix by an actuating device.

### CROSS-REFERENCE TO RELATED APPLICATIONS

This non-provisional application claims priority under 35 U.S.C. § 119 (a) on Patent Application No(s). 112146575 filed in Taiwan on Nov. 30, 2023, the entire contents of which are hereby incorporated by reference.

### BACKGROUND

### 1. Technical Field

The disclosure relates to an array optical system, particularly to a multi-lens coplanar calibration system and method.

### 2. Related Art

Array optical systems, for example, are used in the field of white light interferometry, where the main components of the system are multiple channels arranged in an array, with each channel having a lens or camera. These channels must operate simultaneously to obtain complete information from each channel. The multiple lenses of the array optical system must have the same focal length, and during the system's setup, it is crucial to ensure that these lenses are in the same plane. In the assembly process of the array optical system, it is necessary to adjust the tilt and height of the lenses in each channel to ensure that the lenses in different channels conform to coplanarity.

In the existing technology, laser alignment can only provide height error information for the lenses. Moreover, the optical path design for laser alignment is difficult, and once the optical path setup is offset, it may be impossible to achieve coplanarity for multiple lenses. On the other hand, adjusting coplanarity by observing the imaging clarity between different lenses relies on the operator's personal experience, and this method is not quantifiable, making it more challenging to perform.

### SUMMARY

According to one or more embodiment of the disclosure, a multi-lens coplanar calibration method applicable to a three-dimensional (3D) imaging device with a plurality of lenses is provided. The method comprises: shooting an object by the 3D imaging device through the plurality of lenses to generate a plurality of 3D images, wherein the object comprises a reference surface with known spatial information; calculating a plurality of surface equations according to 3D information of the plurality of 3D images by a computing device; calculating a plurality of coordinate systems corresponding to the plurality of lenses according to the plurality of surface equations, where one of the plurality of coordinate systems is a first coordinate system, and, each of the plurality of coordinate systems other than the first coordinate system is a second coordinate system; calculating a calibration matrix for each second coordinate system relative to the first coordinate system according to at least the plurality of coordinate systems by the computing device; and adjusting one of the plurality of lenses corresponding to the second coordinate system according to the calibration matrix by an actuating device.

According to one or more embodiment of the disclosure, a multi-lens coplanar calibration system includes an object, a 3D imaging device, a computing device, and an actuating device. The object includes a reference surface with known spatial information. The 3D imaging device has a plurality of lenses. The plurality of lenses is configured to shoot the object to generate a plurality of 3D images. The computing device is electrically connected to the 3D imaging device to obtain the plurality of 3D images. The computing device is configured to perform a plurality of instructions to trigger a plurality of operations. The plurality of operations includes: calculating a plurality of surface equations according to 3D information of the plurality of 3D images; calculating a plurality of coordinate systems corresponding to the plurality of lenses according to the plurality of surface equations, wherein each of the plurality of coordinate systems has a specific point as an origin, one of the plurality of coordinate systems is a first coordinate system, and each of the plurality of coordinate systems other than the first coordinate system is a second coordinate system; calculating a calibration matrix for the second coordinate system relative to the first coordinate system according to at least the plurality of coordinate systems. The actuating device is electrically connected to the computing device. The actuating device is configured to adjust one of the plurality of lenses corresponding to the second coordinate system according to the calibration matrix.

### BRIEF DESCRIPTION OF THE DRAWINGS

FIG. 1 is a schematic diagram of the architecture of the multi-lens coplanar calibration system according to an embodiment of the disclosure;

FIG. 2 is a flowchart of the multi-lens coplanar calibration method according to an embodiment of the disclosure;

FIG. 3 is an example of a top view according to the reconstructed point cloud of three-dimensional images captured by 3D imaging device through multiple lenses;

FIG. 4 is an example of a side view according to the reconstructed point cloud of three-dimensional images captured by 3D imaging device through multiple lenses;

FIG. 5 is a detailed flowchart of a step in FIG. 2; and

FIG. 6 is a schematic diagram of the global coordinate system and multiple coordinate systems.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

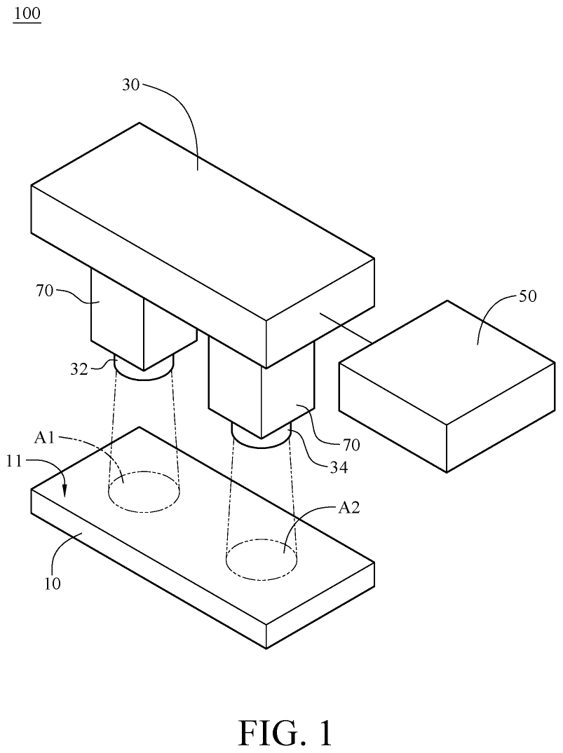

FIG. 1 is a schematic diagram of the architecture of the multi-lens coplanar calibration system according to an embodiment of the disclosure. The multi-lens coplanar calibration system 100 includes an object 10, a three-dimensional (3D) imaging device 30, a computing device 50, and an actuating device 70.

The object 10 includes a reference surface 11 with known spatial information. In an embodiment, the reference surface 11 is a plane, and the plane includes a plurality of positions with same height. In an embodiment, the object 10 is a step height standard produced by VLSI company, which is a standard component processed to have a flat surface. In another embodiment, the reference surface 11 is a surface that can be defined by a mathematical model, such as a curved surface, but the disclosure is not limited thereto.

The 3D imaging device 30 has a plurality of lenses 32, 34. These lenses 32, 34 are configured to shoot the reference surface 11 of the object 10 to generate a plurality of 3D images. As shown in FIG. 1, the number of lenses 32, 34 is at least two, but the present disclosure does not limit the maximum number of lenses 32, 34. In an embodiment, the 3D imaging device 30 is a 3D camera with multiple lenses. In another embodiment, the 3D imaging device 30 is a combination of multiple 3D cameras. The term “3D camera” refers to a camera that uses 3D measurement techniques, such as stereo vision, structured light, or time-of-flight (ToF), to capture 3D images, and the disclosure is not limited to these techniques.

The term “3D image” refers to each pixel in the image containing 3D coordinate information in the world coordinate system. In an embodiment, each lens (32 or 34) of the 3D imaging device 30 directly shoots the object 10 and generates a 3D image. In another embodiment, the generation of 3D images involves adjusting the height of the lenses 32, 34 relative to the reference surface 11 through the actuating device 70. Multiple two-dimensional images of the object 10 are shot at various heights, and the 3D imaging device 30 then creates a 3D image corresponding to each lens (32 or 34) according to these two-dimensional images.

Please note that the area of the reference surface 11 must be larger than the combined fields of view of all lenses 32, 34, as shown in FIG. 1. In other words, when shooting the object 10, it should not be necessary to move the 3D imaging device 30 to allow all lenses 32, 34 to shoot the reference surface 11. Regarding the placement of lenses 32, 34, it must be ensured that there is no overlap portion of the reference surface 11 shot by any two of the lenses 32, 34.

The computing device 50 is electrically connected to the 3D imaging device 30. The computing device 50 obtains the plurality of 3D images captured by the 3D imaging device 30, performs a plurality of instructions according to these 3D images to trigger a plurality of operations, and output a plurality of calibration matrices in the end. These operations correspond to a plurality of steps included in the multi-lens co-planar calibration method according to an embodiment of the disclosure, which will be detailed in the following text.

In an embodiment, the computing device 50 may be implemented by at least one of the following examples: personal computer, network server, microcontroller (MCU), application processor (AP), field-programmable gate array (FPGA), Application-Specific Integrated Circuit (ASIC), system-on-a-chip (SOC), deep learning accelerator, or any electronic device with similar functionality. The hardware type of the computing device 50 is not limited by the disclosure.

The actuating device 70 is electrically connected to the computing device 50. The actuating device 70 performs adjustment according to the calibration matrix to make all lenses 32, 34 coplanar. In one embodiment, the actuating device 70 is, for example, a three-axis servo motor or any mechanical device capable of implementing three-axis adjustments. The disclosure is not limited to this.

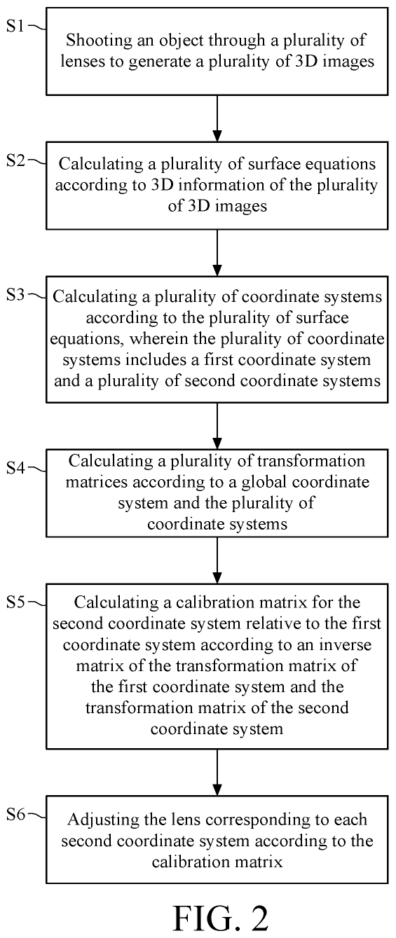

FIG. 2 is a flowchart of the multi-lens coplanar calibration method according to an embodiment of the disclosure. The method includes steps S1-S6 and is applicable to the 3D imaging device 100 with multiple lenses 32, 34.

In step S1, the 3D imaging device 30 shoots an object 10 through the plurality of lenses 32, 34 to generate a plurality of 3D images. The object 10 includes a reference surface 11 with known spatial information.

In step S2, the computing device 50 calculates a plurality of surface equations according to 3D information of the plurality of 3D images. In an embodiment, the surface equation is a plane equation, and the following explanation is based on the embodiment of plane equations.

In an embodiment, before actually calculating the plane equation, the computing device 50 decodes according to the 3D image to obtain a plurality of pieces of 3D information about the reference surface 11. In an embodiment, the 3D information is point cloud.

The computing device 50 sets a region of interest (ROI) in each set of the plurality pieces of 3D information (such as the point cloud) corresponding to each 3D image. Since the target being shot by the 3D imaging device 30 is the reference surface 11, the computing device 50 can generate a virtual surface according to the plurality of pieces of 3D information corresponding to each 3D image and then calculate the surface equation corresponding to this virtual surface.

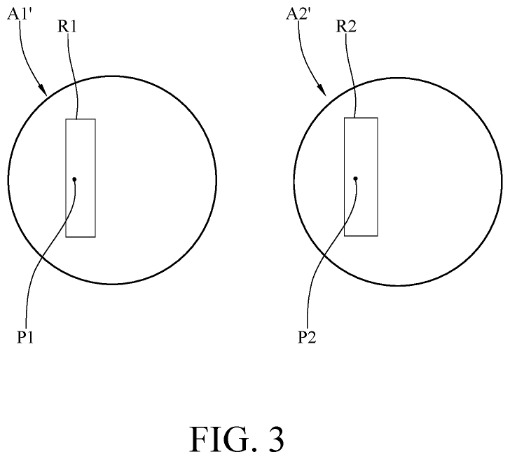

FIG. 3 is an example of a top view according to the reconstructed point cloud of 3D images captured by 3D imaging device 30 through multiple lenses 32, 34. Here, R1 and R2 represent regions of interest (corresponding to the aforementioned virtual surfaces) set by the computing device 50 in the 3D image, and P1 and P2 represent the center points of the regions of interest R1 and R2, respectively.

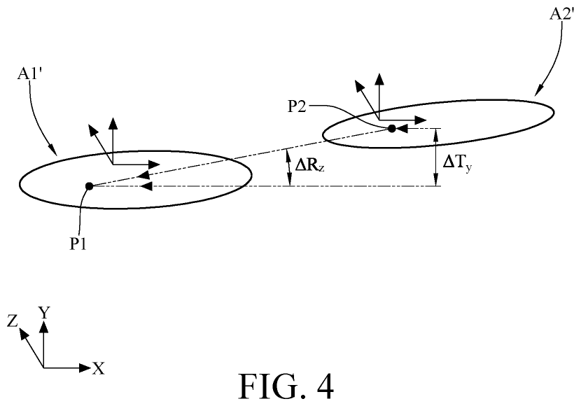

FIG. 4 is an example of a side view according to the reconstructed point cloud of 3D images captured by lenses 32, 34. Please refer to both FIG. 1 and FIG. 4. The shooting ranges of lenses 32 and 34 on the reference surface 11 are denoted as A1 and A2, respectively. The point clouds corresponding to the shooting ranges A1 and A2 are denoted as A1′ and A2′. Since the spatial information of the reference surface 11 is known, when the reference surface 11 is a plane, if all lenses 32 and 34 are coplanar, the point clouds reconstructed from the plurality of 3D images should have the same height. In the example shown in FIG. 4, the point cloud A1′ and the point cloud A2′ have a displacement correction amount ΔTy along the Y-axis and a rotational correction amount ΔR_{z} along the Z-axis. This indicates that lenses 32 and 34 are not coplanar, and it is necessary to adjust one of them (such as the lens 34) through the actuator 70 to align with the other (such as the lens 32).

Since the plurality of pieces of 3D information used to calculate the plane equation are all located within the regions of interest R1 and R2, the computing device 50 can calculate a plurality of plane equations corresponding to the plurality of lenses 32, 34, as shown by Equation 1 below.

$$[ \begin{matrix}{f}_{1} ( x , y , z ) \\ {f}_{2} ( x , y , z ) \\ ⋮ \\ {f}_{N} ( x , y , z )\end{matrix} ] = [ \begin{matrix}{a}_{1} & {b}_{1} & {c}_{1} & {d}_{1} \\ {a}_{2} & {b}_{2} & {c}_{2} & {d}_{2} \\ ⋮ & ⋮ & ⋮ & ⋮ \\ {a}_{N} & {b}_{N} & {c}_{N} & {d}_{N}\end{matrix} ] [ \begin{matrix}x \\ y \\ z \\ 1\end{matrix} ] = [ \begin{matrix}0 \\ 0 \\ 0 \\ 0\end{matrix} ] \qquad ( Equation 1 )$$

where f₁, f₂ . . . , f_{N} represent the plane equations, and a₁ . . . a_{N}, b₁ . . . b_{N}, c₁ . . . , c_{N}, d₁ . . . d_{N} represent the plurality of coefficients in the plane equations. N represents the number of lenses. In the previous exemplary embodiment, N=2.

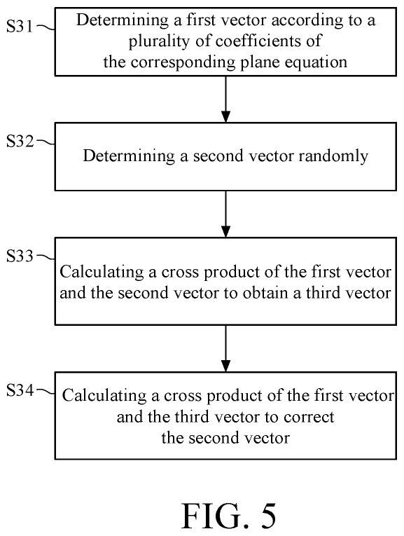

In step S3, the computing device 50 calculates a plurality of coordinate systems according to the plurality of surface equations. FIG. 5 is a detailed flowchart of step S3 in FIG. 2, and includes steps S31 to S34.

The computing device 50 performs the process shown in FIG. 5 for each plane equation to obtain a coordinate system. If the number of lenses is N, the computing device 50 performs the process shown in FIG. 5 N times to calculate N coordinate systems. Each coordinate system has a specific point as its origin, such as the previously mentioned center points P1 or P2.

In step S31, the computing device 50 determines a first vector according to the plurality of coefficients of the corresponding plane equation. The first vector is the normal vector of the plane. For example, for the plane equation f₁=a₁x+b₁y+c₁z+d₁=0, the first vector is V_{z1}=(a, b, c).

In step S32, the computing device 50 randomly determines a second vector. The values of the second vector can be arbitrarily chosen. For example, the second vector is Vₓ₁=(1,0,0).

In step S33, the computing device 50 calculates a cross product of the first vector and the second vector to obtain a third vector. In other words, the third vector is V_{y1}=V_{z1}×Vₓ₁. After step S33 is completed, at least it ensures the orthogonality between the first vector V_{z1} and the third vector V_{y1}.

In step S34, the computing device 50 calculates a cross product of the first vector and the third vector to correct the second vector. In other words, the corrected second vector is Vₓ₁=V_{y1}×V_{z1}. After step S34 is completed, it ensures the orthogonality between the first vector V_{z1} and the corrected second vector Vₓ₁, and the orthogonality between the third vector V_{y1} and the corrected second vector Vₓ₁, thus forming a coordinate system with mutually orthogonal vectors Vₓ₁, V_{y1}, V_{z1}.

Each of the plurality of coordinate systems mentioned in step S3 is composed of the first vector, the second vector, and the third vector. Each coordinate system corresponds to a lens (such as 32 or 34). To make all lenses 32, 34 coplanar, one of these coordinate systems is chosen as the reference and called the first coordinate system, while each of the others that needs adjustment is referred to as the second coordinate system. The goal of adjustment is to align each second coordinate system with the first coordinate system.

In the processes of steps S4 and S5, the computing device 50 calculates a calibration matrix for the second coordinate system relative to the first coordinate system at least according to the plurality of coordinate systems.

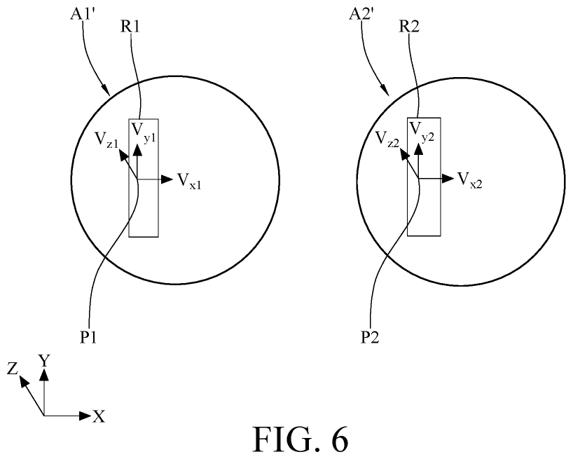

In step S4, the computing device 50 calculates a plurality of transformation matrices according to a global coordinate system and the plurality of coordinate systems. FIG. 6 is a schematic diagram of the global coordinate system and multiple coordinate systems. Each transformation matrix is configured to transform the corresponding coordinate system, such as {Vₓ₁, V_{y1}, V_{z1}} or {Vₓ₂, V_{y2}, V_{z2}}, to the global coordinate system {x, y, z}. The calculation of transformation matrix is as shown by Equation 2 below:

$$M = [ \begin{matrix}{x}_{0} & {x}_{1} & {x}_{2} & {P}_{x} \\ {y}_{0} & {y}_{1} & {y}_{2} & {P}_{y} \\ {z}_{0} & {z}_{1} & {z}_{2} & {P}_{z} \\ 0 & 0 & 0 & 1\end{matrix} ] \qquad ( Equation 2 )$$

where M represents the transformation matrix, (x₀, y₀, z₀), (x₁, y₁, z₁), (x₂, y₂, z₂) represent the three-axis vectors constituting the coordinate system, and (Pₓ, P_{y}, P_{z}) represents the coordinates of a specific point, which is the center point P1 of the region of interest R1.

In step S5, the computing device 50 calculates a calibration matrix for the second coordinate system relative to the first coordinate system according to an inverse matrix of the transformation matrix of the first coordinate system and the transformation matrix of the second coordinate system. The calibration matrix is configured to transform the second coordinate system into the first coordinate system, and its calculation is as shown by Equation 3 below.

$${M}_{C} = {M}_{1}^{- 1} \times {M}_{2} \qquad ( Equation 3 )$$

where M_{C} represents the correction matrix, M₁ represents the transformation matrix of the first coordinate system, and M₂ represents the transformation matrix of the second coordinate system.

In step S6, the computing device 50 adjusts the lens corresponding to each second coordinate system according to the calibration matrix Mc. In other words, the computing device 50 calculates the rotation correction amount and the displacement correction amount as shown by Equation 4 below.

$${M}_{C} = [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ] = ( R \vert T ) \qquad ( Equation 4 )$$

where

$$R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ]$$

represents a rotation correction matrix,

$$T = [ \begin{matrix}{t}_{1} \\ {t}_{2} \\ {t}_{3}\end{matrix} ]$$

represents a displacement correction matrix, and the rotation correction amounts for the three axes can be calculated according to the rotation correction matrix R and Equation 5 below.

$$( Equation 5 )$$

$$R = [ \begin{matrix}\begin{matrix}cos ( {θ}_{y} ) cos ( {θ}_{z} ) - \\ sin ( {θ}_{x} ) sin ( {θ}_{y} ) sin ( {θ}_{z} )\end{matrix} & - cos ( {θ}_{x} ) sin ( {θ}_{z} ) & \begin{matrix}sin ( {θ}_{y} ) cos ( {θ}_{z} ) + \\ sin ( {θ}_{x} ) cos ( {θ}_{y} ) sin ( {θ}_{z} )\end{matrix} \\ \begin{matrix}cos ( {θ}_{y} ) sin ( {θ}_{z} ) + \\ sin ( {θ}_{x} ) sin ( {θ}_{y} ) cos ( {θ}_{z} )\end{matrix} & cos ( {θ}_{x} ) cos ( {θ}_{z} ) & \begin{matrix}sin ( {θ}_{y} ) sin ( {θ}_{z} ) - \\ sin ( {θ}_{x} ) cos ( {θ}_{y} ) cos ( {θ}_{z} )\end{matrix} \\ - cos ( {θ}_{x} ) sin ( {θ}_{y} ) & sin ( {θ}_{x} ) & cos ( {θ}_{x} ) cos ( {θ}_{y} )\end{matrix} ]$$

where θₓ represents the rotation correction amount about the X-axis, θ_{y} represents the rotation correction amount about the Y-axis, and θ_{z} represents the rotation correction amount about the Z-axis. (θₓ, θ_{y}, θ_{z}) form the rotation correction amounts ΔR. The displacement correction amount ΔT_{z} can be directly obtained from the displacement correction matrix T of the correction matrix M_{c}. Generally, this displacement correction amount is only applicable to the Z-axis.

Finally, the actuating device 70 adjusts each lens corresponding to the second coordinate system according to the rotation correction amount ΔR and the displacement correction amount ΔT_{z}, aligning them with the lenses corresponding to the first coordinate system.

In summary, embodiments of the disclosure provide a multi-lens coplanar correction system and method that can obtain height and angle information for each lens to achieve coplanar adjustment. This not only has a higher success rate in coplanar adjustment but also allows for the quantification of height and angle errors for each lens. It reduces the user's operational difficulty and is more suitable for introducing automated adjustment mechanisms.

What is claimed is:

1. A multi-lens coplanar calibration method applicable to a three-dimensional (3D) imaging device with a plurality of lenses, wherein the method comprises:
shooting an object by the 3D imaging device through the plurality of lenses to generate a plurality of 3D images, wherein the object comprises a reference surface with known spatial information;
calculating a plurality of surface equations according to 3D information of the plurality of 3D images by a computing device;
calculating a plurality of coordinate systems corresponding to the plurality of lenses according to the plurality of surface equations by the computing device, wherein each of the plurality of coordinate systems has a specific point as an origin, one of the plurality of coordinate systems is a first coordinate system, and each of the plurality of coordinate systems other than the first coordinate system is a second coordinate system;
calculating a calibration matrix for the second coordinate system relative to the first coordinate system according to at least the plurality of coordinate systems by the computing device; and
adjusting one of the plurality of lenses corresponding to the second coordinate system according to the calibration matrix by an actuating device.

2. The multi-lens coplanar calibration method of claim 1, wherein calculating the calibration matrix for each second coordinate system relative to the first coordinate system at least according to the plurality of coordinate systems by the computing device comprises:
calculating a plurality of transformation matrices according to a global coordinate system and the plurality of coordinate systems, wherein each of the plurality of transformation matrices is configured for a transformation between corresponding one of the plurality of coordinate systems and the global coordinate system; and
calculating the calibration matrix according to the transformation matrix of the first coordinate system and the transformation matrix of the second coordinate system.

3. The multi-lens coplanar calibration method of claim 2, wherein calculating the calibration matrix according to the transformation matrix of the first coordinate system and the transformation matrix of the second coordinate system comprises:
calculating an inverse matrix according to the transformation matrix of the first coordinate system; and
calculating the calibration matrix of the second coordinate system relative to the first coordinate system according to the inverse matrix and the transformation matrix of the second coordinate system.

4. The multi-lens coplanar calibration method of claim 1, wherein the 3D information is point cloud; and
calculating the plurality of surface equations according to the 3D information of the plurality of 3D images by the computing device comprises:
generating a plurality of virtual surfaces according to the point cloud of the plurality of 3D images by the computing device; and
calculating the plurality of surface equations corresponding to the plurality of virtual surfaces by the computing device.

5. The multi-lens coplanar calibration method of claim 1, wherein each of the plurality of coordinate systems comprises a first vector, a second vector and a third vector, and calculating the plurality of coordinate systems corresponding to the plurality of lenses according to the plurality of surface equations by the computing device comprises:
for each of the plurality of coordinate systems, determining the first vector according to a plurality of coefficients of corresponding one of the plurality of surface equations;
randomly determining the second vector;
calculating a cross product of the first vector and the second vector to obtain the third vector; and
calculating a cross product of the first vector and the third vector to correct the second vector.

6. The multi-lens coplanar calibration method of claim 2, further comprising: before calculating the plurality of surface equations according to the 3D information of the plurality of 3D images by the computing device, setting a region of interest for each of the plurality of 3D images by the computing device.

7. The multi-lens coplanar calibration method of claim 6, wherein each of the plurality of transformation matrices is
$$[ \begin{matrix}{x}_{0} & {x}_{1} & {x}_{2} & {P}_{x} \\ {y}_{0} & {y}_{1} & {y}_{2} & {P}_{y} \\ {z}_{0} & {z}_{1} & {z}_{2} & {P}_{z} \\ 0 & 0 & 0 & 1\end{matrix} ] ,$$
wherein (x₀, y₀, z₀), (x₁, y₁, z₁), and (x₂, y₂, z₂) are three-axis vectors forming each of the plurality of coordinate systems, and (Pₓ, P_{y}, P_{z}) is the specific point, wherein the specific point is the center of the region of interest.

8. The multi-lens coplanar calibration method of claim 1, where the reference surface is a plane, and the plane includes a plurality of positions with same height.

9. A multi-lens coplanar calibration system comprising:
an object comprising a reference surface with known spatial information;
a three-dimensional (3D) imaging device with a plurality of lenses, wherein the 3D imaging device is configured to shoot the reference surface of object through the plurality of lenses to generate a plurality of 3D images;
a computing device electrically connected to the 3D imaging device to obtain the plurality of 3D images, wherein the computing device is configured to perform a plurality of instructions to trigger a plurality of operations, wherein the plurality of operations comprises:
calculating a plurality of surface equations according to 3D information of the plurality of 3D images;
calculating a plurality of coordinate systems corresponding to the plurality of lenses according to the plurality of surface equations, wherein each of the plurality of coordinate systems has a specific point as an origin, one of the plurality of coordinate systems is a first coordinate system, and each of the plurality of coordinate systems other than the first coordinate system is a second coordinate system;
calculating a calibration matrix for the second coordinate system relative to the first coordinate system according to at least the plurality of coordinate systems; and
an actuating device electrically connected to the computing device, wherein the actuating device is configured to adjust one of the plurality of lenses corresponding to the second coordinate system according to the calibration matrix.

10. The multi-lens coplanar calibration system of claim 9, wherein in the plurality of operations, calculating the calibration matrix for each second coordinate system relative to the first coordinate system at least according to the plurality of coordinate systems by the computing device comprises:
calculating a plurality of transformation matrices according to a global coordinate system and the plurality of coordinate systems, wherein each of the plurality of transformation matrices is configured for a transformation between corresponding one of the plurality of coordinate systems and the global coordinate system; and
calculating the calibration matrix according to the transformation matrix of the first coordinate system and the transformation matrix of the second coordinate system.

11. The multi-lens coplanar calibration system of claim 10, wherein in the plurality of operations, calculating the calibration matrix according to the transformation matrix of the first coordinate system and the transformation matrix of the second coordinate system comprises:
calculating an inverse matrix according to the transformation matrix of the first coordinate system; and
calculating the calibration matrix of the second coordinate system relative to the first coordinate system according to the inverse matrix and the transformation matrix of the second coordinate system.

12. The multi-lens coplanar calibration system of claim 9, wherein the 3D information is point cloud; and in the plurality of operations, calculating the plurality of surface equations according to the 3D information of the plurality of 3D images by the computing device comprises:
generating a plurality of virtual surfaces according to the point cloud of the plurality of 3D images;
calculating the plurality of surface equations corresponding to the plurality of virtual surfaces.

13. The multi-lens coplanar calibration system of claim 9, wherein each of the plurality of coordinate systems comprises a first vector, a second vector and a third vector, and calculating the plurality of coordinate systems corresponding to the plurality of lenses according to the plurality of surface equations by the computing device comprises:
for each of the plurality of coordinate systems, determining the first vector according to a plurality of coefficients of corresponding one of the plurality of surface equations;
randomly determining the second vector;
calculating a cross product of the first vector and the second vector to obtain the third vector; and
calculating a cross product of the first vector and the third vector to correct the second vector.

14. The multi-lens coplanar calibration system of claim 10, wherein the plurality of operations further comprises: before calculating the plurality of surface equations according to the 3D information of the plurality of 3D images by the computing device, setting a region of interest for each of the plurality of 3D images by the computing device.

15. The multi-lens coplanar calibration system of claim 14, wherein each of the plurality of transformation matrices is
$$[ \begin{matrix}{x}_{0} & {x}_{1} & {x}_{2} & {P}_{x} \\ {y}_{0} & {y}_{1} & {y}_{2} & {P}_{y} \\ {z}_{0} & {z}_{1} & {z}_{2} & {P}_{z} \\ 0 & 0 & 0 & 1\end{matrix} ] ,$$
wherein (x₀, y₀, z₀), (x₁, y₁, z₁), and (x₂, y₂, z₂) are three-axis vectors forming each of the plurality of coordinate systems, and (Pₓ, P_{y}, P_{z}) is the specific point, wherein the specific point is the center of a region of interest.

16. The multi-lens coplanar calibration method of claim 9, where the reference surface is a plane, and the plane includes a plurality of positions with same height.
